(19) United States
(12) Patent Application Publication
(10) Pub. No.: US 2016/0170349 A1
(43) Pub. Date: Jun. 16, 2016

(54) FIXING DEVICE AND IMAGE FORMING APPARATUS

(71) Applicant: KYOCERA Document Solutions Inc., Osaka (JP)

(72) Inventor: Eiji NAKAJIMA, Osaka-shi (JP)

(73) Assignee: KYOCERA Document Solutions Inc., Osaka (JP)

(21) Appl. No.: 14/955,640

(22) Filed: Dec. 1, 2015

(30) Foreign Application Priority Data
Dec. 15, 2014 (JP) 2014-252673

(51) Int. Cl. G03G 15/20

(52) U.S. Cl. CPC G03G 15/2053

(57) ABSTRACT

A fixing device includes a fixing shaft part, a fixing belt, a pressure roller, an induction heating coil, a movement limiting member and a magnetic flux suppressing part. The induction heating coil faces to an outside part of the fixing belt provided outside the fixing shaft part, and is wired between one end and another end in an axial direction to heat the fixing belt. The movement limiting member is provided on the fixing shaft part at the outside from an end part of the fixing belt in the axial direction to limit axial movement of the fixing belt with respect to the fixing shaft part. The magnetic flux suppressing part extends inwardly from the movement limiting member in the axial direction, and interrupts between the induction heating coil and the end part to suppress magnetic fluxes generated by the induction heating coil from passing through the end part.

### INCORPORATION BY REFERENCE

This application is based on and claims the benefit of priority from Japanese Patent application No. 2014-252673 filed on Dec. 15, 2014, the entire contents of which are incorporated herein by reference.

### BACKGROUND

The present disclosure relates to a fixing device fixing an image on a recording medium, such as a sheet, and an image forming apparatus including the fixing device.

For example, an electro-photographic image forming apparatus applicable to a printer, a copying machine, a facsimile, a multifunction peripheral or the like is configured to form a toner image by visualizing an electrostatic latent image formed on a photosensitive body by a toner, to transfer the toner image on a sheet, and then, to fix the toner image on the sheet by passing the sheet through a fixing device.

In general, the fixing device includes a fixing unit having a fixing belt or a fixing roller, a heat source heating the fixing belt or the fixing roller, and a pressure roller pressed against the fixing belt or the fixing roller to form a nip part with the fixing belt or the fixing roller. Then, the fixing device fixes the toner image on the sheet by applying heat and pressure onto the toner image on the sheet when the sheet is passed through the nip part. As the heat source, a heater generating heat by electric power supplied from a power source is used. The pressure roller is rotationally driven by a motor or the like, and the fixing belt or the fixing roller rotates by receiving a rotational force of the pressure roller pressed against a circumferential face the fixing belt or the fixing roller.

The fixing device has such problems that the electric power consumed for heating the fixing belt or the fixing roller should be cut or a time (a stabling time) taken to heat the fixing belt or the fixing roller to a predetermined temperature in starting an operation should be shortened. In recent years, in order to solve such problems, development of a fixing unit having small thermal capacity is tried.

As one of the fixing unit having the small thermal capacity, there is developed one in which a cylindrical elastic member is provided around a columnar or cylindrical fixing shaft part and a thin endless fixing belt is covered around the elastic member. The fixing unit having such configuration is called as a “uniaxial type”, but a conventional fixing unit having a fixing belt stretched between two rollers is called as a “biaxial type”.

In the uniaxial type fixing unit, the fixing shaft part, the elastic member, and the fixing belt rotate in a body by receiving the rotational force of the pressure roller. However, while the elastic member provided around the fixing shaft part is fastened (unmovably attached) to the fixing shaft part, the fixing belt provided around the elastic member is not fixed (movably attached) to the elastic member. Accordingly, the fixing belt is movable in an axial direction or in a circumferential direction with respect to the elastic member.

Then, the uniaxial type fixing unit is provided with movement limiting members limiting axial movement (meandering or shifting) of the fixing belt with respect to the elastic member. The movement limiting members are provided respectively on both sides of the fixing belt in the axial direction. Each movement limiting member is disposed at the outside of each end part of the fixing belt in the axial direction so as to face to each end face of the fixing belt. Specifically, each movement limiting member is formed into a disk-like shape and is provided with a hole at a center thereof. Each movement limiting member is fixed to the fixing shaft part by attaching the hole to the fixing shaft part. For example, when the fixing belt moves to one side in the axial direction, the end face of the one end of the fixing belt abuts against the movement limiting member and thereby, the movement of the fixing belt in the axial direction is limited.

Meanwhile, in recent years, development of a fixing device using an induction heating coil as a heat source is tried. The induction heating coil excels in heating efficiency. Accordingly, in recent years, in order to solve the abovementioned problems, a fixing device in which the induction heating coil and the uniaxial type fixing unit are combined is proposed.

The induction heating coil is disposed at a position facing to a part of an outer circumferential side of the fixing belt and is formed by winding a lead wire in the axial direction of the fixing belt. Specifically, the induction heating coil is formed by repeatedly wiring the lead wire at the position facing to the part of the outer circumferential side of the fixing belt so as to straightly stretch the lead wire from one end to another end in the axial direction of the fixing belt and then to curve the lead wire at the other end of the fixing belt and further so as to straightly stretch the lead wire from the other end to the one end of the fixing belt and then to curve the lead wire at the one end of the fixing belt.

The induction heating coil having such configuration has a straight part and a turning part. That is, a part where the lead wire stretches straightly between the one end and the other end of the fixing belt is the straight part, and a part where the lead wire is curved at the one end or the other end of the fixing belt is the turning part.

When the fixing belt is heated by the induction heating coil, a main layer of the fixing belt having a multi-layered structure is formed by magnetic metal. Then, an alternating current is flown to the induction heating coil to generate magnetic fluxes passing through an outer circumferential face of the fixing belt. As a result, eddy currents are generated in a magnetic metal layer of the fixing belt by electromagnetic induction, and the magnetic metal layer is heated.

Incidentally, the lead wires are concentrated in the turning part of the induction heating coil as compared to the straight part. Due to that, as compared to the straight part, magnetic flux density of the generated magnetic fluxes becomes high at the turning part. Accordingly, in a case where the turning part of the induction heating coil and the end part of the fixing belt face to each other, the magnetic flux density of the magnetic fluxes passing through the end part of the fixing belt becomes higher than the magnetic flux density of the magnetic fluxes passing through an intermediate part of the fixing belt. As a result, heating temperature of the end part of the fixing belt becomes higher than heating temperature of the intermediate part of the fixing belt, and there is a possibility that temperature rise of the end part of the fixing belt becomes excessive. The excessive temperature rise of the fixing belt may drop strength of the fixing belt or worsen durability of the fixing belt.

Still further, in the uniaxial type fixing unit as mentioned above, the fixing belt is not fastened to the elastic member and is movable in the axial direction. While the movement limiting members are provided at the both end sides of the fixing belt as mentioned above and the movement of the fixing belt in the axial direction is limited by the respective movement limiting members, the fixing belt is allowed to move by a short distance in the axial direction. Therefore, if the fixing belt moves, for example, to the other side in the axial direction with respect to the elastic member, a gap is made between the end part of the one side of the fixing belt and the movement limiting member provided at the one side of the fixing shaft part. If the gap is thus made between the end part of the fixing belt and the movement limiting member, the magnetic fluxes generated by the induction heating coil enter into the inside of the fixing belt by passing through the gap. Thus, the magnetic fluxes generated by the induction heating coil enter/exit not only into/from the outer circumferential face of the fixing belt, but also into/from an inner circumferential face of the fixing belt. As a result, there is a possibility that the temperature rise of the end part of the fixing belt becomes excessive.

### SUMMARY

A fixing device of the present disclosure is a fixing device fixing an image on a recording medium. The fixing device includes a fixing shaft part rotatable around a first axis, an endless fixing belt, a pressure roller, an induction heating coil, a movement limiting member, and a magnetic flux suppressing part. The fixing belt is provided movably with respect to the fixing shaft part at an outer circumferential side of the fixing shaft part. The pressure roller is provided rotatably around a second axis in parallel with the first axis and forms a nip part with the fixing belt by being pressed against the fixing belt. The induction heating coil is disposed at a position facing to a part at the outer circumferential side of the fixing belt, is formed by repeatedly wiring a lead wire so as to straightly stretch the lead wire from one end to another end in an axial direction of the fixing belt and then to curve the lead wire at the other end of the fixing belt and further so as to straightly stretch the lead wire from the other end to the one end of the fixing belt and then to curve the lead wire at the one end of the fixing belt, and is configured so as to heat the fixing belt. The movement limiting member is provided on the fixing shaft part, is disposed at the outside in the axial direction from an end part at one side or another side in the axial direction of the fixing belt so as to face to an end face of the end part of the fixing belt, and is configured so as to limit movement in the axial direction of the fixing belt with respect to the fixing shaft part. The magnetic flux suppressing part is formed in an outer circumferential part of the movement limiting member, extends from the outer circumferential part of the movement limiting member to the inside of the fixing belt in the axial direction, and interrupts between a part of the induction heating coil facing to the end part of the fixing belt and the end part of the fixing belt to suppress magnetic fluxes generated by the induction heating coil from passing through the end part of the fixing belt.

An image forming apparatus of the present disclosure includes the fixing device as described above.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view illustrating an image forming apparatus including a fixing device of a first embodiment of the present disclosure.

FIG. 2 is a sectional view of the fixing device viewed from a direction of arrows II-II in FIG. 1.

FIG. 3 is a sectional view illustrating a fixing unit, a pressure roller, a heater unit, and others viewed from a direction of arrows III-III in FIG. 2.

FIG. 4 is a sectional view illustrating end parts at one side of the fixing unit, the pressure roller, the heater unit, and others in FIG. 2.

FIG. 5 is a plan view illustrating an induction heating coil in the fixing device of the first embodiment of the present disclosure.

FIG. 6 is a perspective view illustrating a movement limiting member and a magnetic flux suppressing part in the fixing device of the first embodiment of the present disclosure.

FIG. 7 is an enlarged sectional view illustrating a part where the end part of the fixing belt and a turning part of the induction heating coil face to each other in the fixing device of the first embodiment of the present disclosure.

FIG. 8 is an enlarged sectional view illustrating a part where an end part of a fixing belt and a turning part of an induction heating coil face to each other in a fixing device of a first comparative example.

FIG. 9 is an enlarged sectional view illustrating a part where an end part of a fixing belt and a turning part of an induction heating coil face to each other in a fixing device of a second comparative example.

FIG. 10 is a sectional view illustrating the end part of the fixing unit, the movement limiting member, the magnetic flux suppressing part, a sliding contact member, and others in the fixing device of a second embodiment of the present disclosure.

### DETAILED DESCRIPTION

### First Embodiment

A first embodiment of the present disclosure will be described with reference to the drawings.

(Image Forming Apparatus)

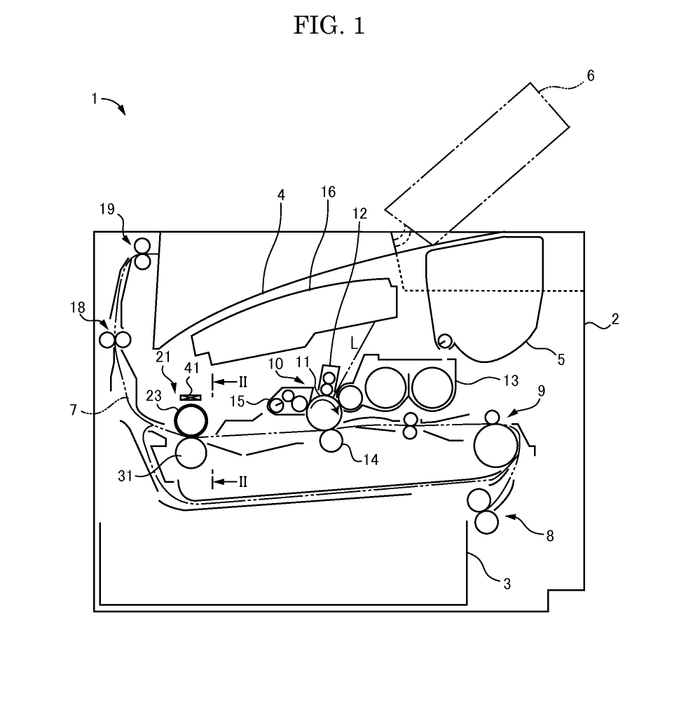

FIG. 1 illustrates an image forming apparatus including a fixing device of the first embodiment of the present disclosure. In FIG. 1, the image forming apparatus 1 of the first embodiment of the present disclosure is an electro-photographic image forming apparatus, e.g., a printer. The image forming apparatus 1 includes a roughly box-like formed housing 2 and, in a lower part of the housing 2, a sheet feeding cassette 3 is provided. The sheet feeding cassette 3 stores sheets as recording mediums. In an upper part of the housing 2, an ejected sheet tray 4 is provided. Still further, in the upper part of the housing 2, an installation part used for installing a toner container 5 is provided, and the housing 2 is provided with a lid part 6 opening/closing the installation part.

Inside the housing 2, a conveying path 7 for conveying the sheet stored in the sheet feeding cassette 3 to the ejected sheet tray 4 is arranged. At an upstream side of the conveying path 7, a sheet feeding roller 8 is provided and, at a downstream side from the sheet feeding roller 8, a conveying roller 9 is provided. At a downstream side from the sheet feeding roller 8, an image forming part 10 is provided. The image forming part 10 includes a photosensitive drum 11, a charger 12, a development device 13, a transferring roller 14, and a cleaning device 15. Moreover, above the image forming part 10, an exposure device 16 is provided. Further, at a downstream side from the image forming part 10 in the conveying path 7, a fixing device 21 of the first embodiment of the present disclosure is provided. The fixing device 21 includes a fixing unit 23, a pressure roller 31, a heater unit 41, and others as described later. Still further, at a downstream side from the fixing device 21, a conveying roller 18 is provided and, at a downstream side from the conveying roller 18 and in a vicinity of the ejected sheet tray 4, a sheet ejecting roller 19 is provided.

Still further, although not shown, the image forming apparatus 1 includes a storage part, a control part and a power circuit. The storage part has a semiconductor storage device and temporarily stores image data received from an external device, such as a personal computer. The control part has an arithmetic processing device and controls the exposure device 16, the image forming part 10, the fixing device 21 and others. The power circuit controls supply of electric power for operating the image forming apparatus 1.

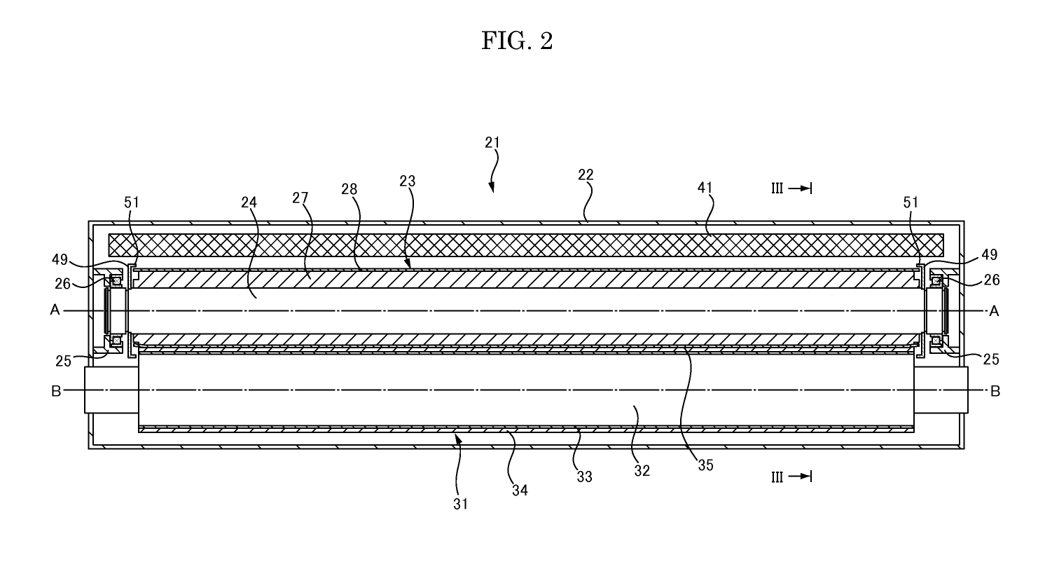

A printing operation of the image forming apparatus 1 with a configuration as described above will be described as follows. That is, when image data to be printed on a sheet is inputted to the image forming apparatus 1, a surface of the photosensitive drum 11 is electrically charged by the charger 12, a laser beam L corresponding to the image data is irradiated from the exposure device 16 to the photosensitive drum 11, and thus an electrostatic latent image is formed on the surface of the photosensitive drum 11. Further, a toner image corresponding to the electrostatic latent image is formed on the surface of the photosensitive drum 11 by the development device 13. Meanwhile, the sheet stored in the sheet feeding cassette 3 is conveyed by the sheet feeding roller 8 and the conveying roller 9 and passes between the photosensitive drum 11 and the transferring roller 14. At this time, the toner image formed on the surface of the photosensitive drum 11 is transferred onto a surface of the sheet. After the toner image is transferred, the toner remained on the surface of the photosensitive drum 11 is collected by the cleaning device 15. In succession, the sheet on which the toner image has been transferred passes through between a fixing belt 28 (see FIG. 2) and the pressure roller 31 of the fixing device 21. At this time, the toner image is molten by heat of the fixing belt 28 heated by the heater unit 41 and is pressed to the sheet by a pressing force applied between the fixing belt 28 and the pressure roller 31. As a result, the toner image is fixed onto the sheet. The sheet on which the toner image has been fixed is conveyed by the conveying roller 18 and the sheet ejecting roller 19 and is ejected onto the ejected sheet tray 4.

(Fixing Device)

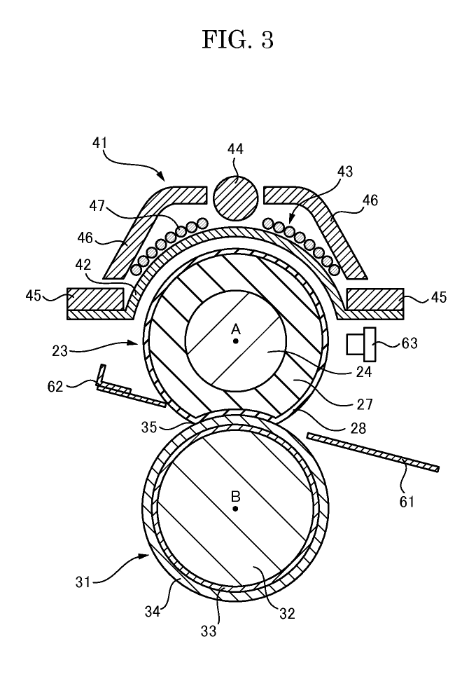

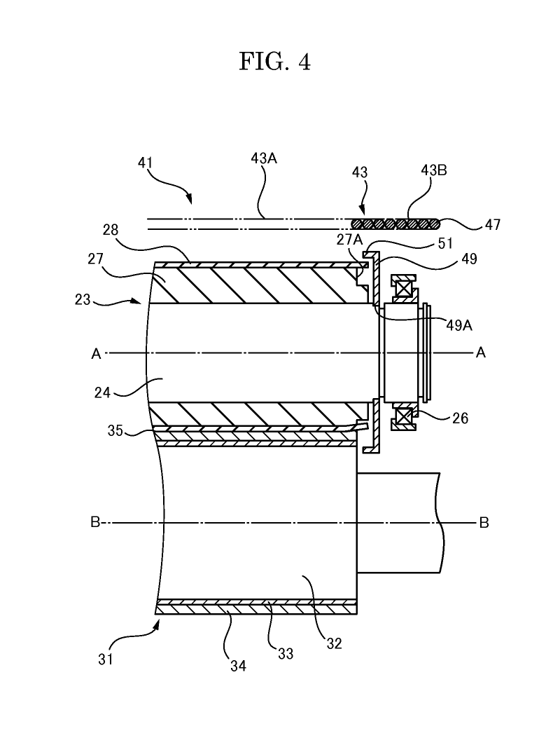

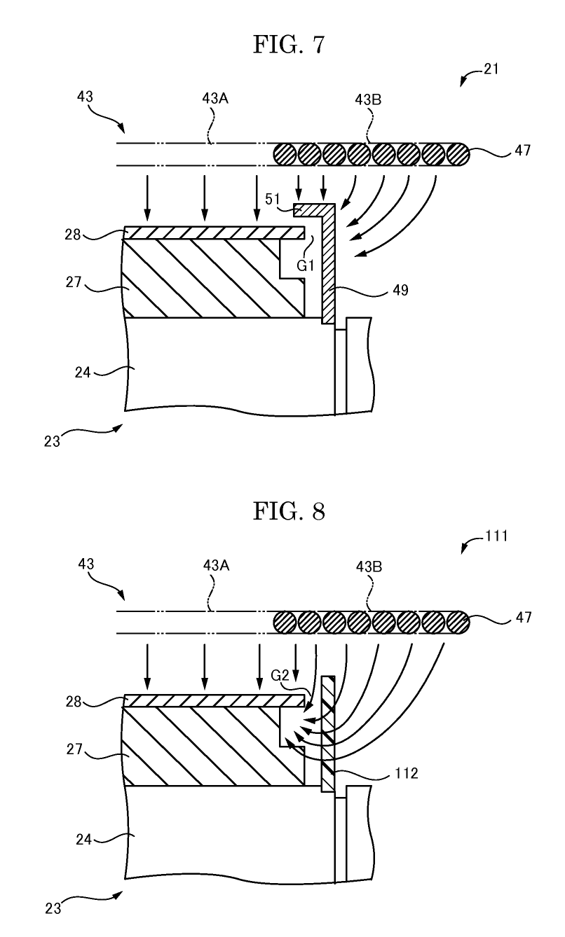

FIG. 2 illustrates the fixing device 21 seen from a direction of arrows II-II in FIG. 1. It is noted that, in FIG. 2, the heater unit 41 is schematically illustrated. FIG. 3 illustrates sections of the fixing unit 23, the pressure roller 31, the heater unit 41, and others seen from a direction of arrows III-III in FIG. 2. FIG. 4 illustrates end parts at one side of the fixing unit 23, the pressure roller 31, the heater unit 41 and others in FIG. 2. It is noted that, in FIG. 4, the disposition of an induction heating coil 43 of the heater unit 41 is simplified (this applies also in FIGS. 7-9 as described later).

In FIG. 2, the fixing device 21 includes a frame part 22 formed of a metal plate, for example, and composing an outer frame of the fixing device 21. Within the frame part 22, the fixing unit 23, the pressure roller 31, and the heater unit 41 are attached.

The fixing unit 23 includes a fixing shaft part 24, an elastic member 27 and the fixing belt 28.

The fixing shaft part 24 is a member supporting the elastic member 27 and the fixing belt 28. The fixing shaft part 24 is formed into a columnar or a cylindrical shape by nonmagnetic metal, such as aluminum. A length in an axial direction of the fixing shaft part 24 is set to be longer than a width of a maximum size sheet that can be handled by the image forming apparatus 1. Both end parts of the fixing shaft part 24 are rotatably supported by supporting parts 25 provided on side plate parts of the frame part 22 through bearings 26 around a first axis (axis A-A).

The elastic member 27 is a member supporting the fixing belt 28. The elastic member 27 is formed into a cylindrical shape, for example, by elastically deformable material, such as foamed silicon rubber. A length in the axial direction of the elastic member 27 is set to be longer than the width of the maximum size sheet that can be handed by the image forming apparatus 1. The elastic member 27 is adhered and fixed to the outer circumferential side of the fixing shaft part 24.

As shown in FIG. 3, when the pressure roller 31 is pressed against the fixing belt 28, the elastic member 27 deforms so as to largely dent inwardly together with the fixing belt 28. by thus largely deforming the elastic member 27, it is possible to increase an area of a nip part 35 formed between an outer circumferential face of the fixing belt 28 and an outer circumferential face of the pressure roller 31 and to reliably carry out heating and pressuring of the toner image onto the sheet. Thereby, it is possible to enhance quality of color printing that requires much toner in forming an image as compared to monochrome printing.

Moreover, as shown in FIG. 4, stepped parts 27A are formed at an outer circumferential side of both end parts of the elastic member 27 in the axial direction, and thereby, diameters of the both end parts of the elastic member 27 are reduced as compared to other parts. Thereby, when the pressure roller 31 is pressed against the fixing belt 28, parts pressed by the pressure roller 31 at end parts of the fixing belt 28 deform so as to enter inwardly.

The fixing belt 28 is a member applying heat to the toner image on the sheet to melt the toner image. The fixing belt 28 is a thin deformable endless belt and is formed into a cylindrical shape as a whole. A width of the fixing belt 28 is set to be longer than the width of the maximum-size sheet that can be handled by the image forming apparatus 1. For instance, the fixing belt 28 is formed by providing an elastic layer formed of silicon rubber or the like with a thickness of about 0.3 mm around a base layer formed of magnetic metal such as nickel or the like with a thickness of around 35 μm and by coating a surface of the elastic layer by a tube formed of perfluoroalkoxy fluoric resin (PFA) or the like. It is noted that such multi-layered structure of the fixing belt 28 is not illustrated in the figures.

The fixing belt 28 is provided on an outer circumferential side of the elastic member 27. The fixing belt 28 is not adhered to the elastic member 27 and is movable with respect to the elastic member 27 in the axial direction or in a circumferential direction. It is possible to suppress the fixing belt 28 from being loosened or wrinkled during the fixing operation by allowing movement of the fixing belt 28 as described above.

The pressure roller 31 is a member pressuring the toner image on the sheet to fix, onto the sheet, the toner image melted by the heat applied from the fixing belt 28. For instance, the pressure roller 31 includes a core metal part 32 formed of aluminum or the like, an intermediate layer 33 provided around an outer circumferential side of the core metal part 32 and formed of silicon rubber or the like, and a surface layer 34 provided around an outer circumferential side of the intermediate layer 33 and formed of PFA or the like. As shown in FIG. 2, the pressure roller 31 is rotatably supported by the frame part 22 around a second axis (axis B-B) in parallel with the first axis (axis A-A). The pressure roller 31 is pressed against the fixing belt 28 by a mechanism (not shown) and thereby, forms the nip part 35 with the fixing belt 28.

Moreover, the fixing device 21 is provided with a driving source, e.g., a motor, and a power transmitting mechanism (both not shown) for rotationally driving the pressure roller 31. During the fixing operation, the pressure roller 31 is rotated by being driven by the driving source and the fixing unit 23 is rotated by receiving rotation of the pressure roller 31. It is noted that the fixing shaft part 24, the elastic member 27, and the fixing belt 28 of the fixing unit 23 rotate in a body by receiving the rotation of the pressure roller 31. While the fixing belt 28 is movable with respect to the elastic member 27, the fixing belt 28 is unable to rotate freely independently from the elastic member 27. The movement of the fixing belt 28 is limited by friction between the fixing belt 28 and the elastic member 27.

The heater unit 41 is a device heating the fixing belt 28. The heater unit 41 is disposed at a position facing to a part of the outer circumferential side of the fixing belt 28. In the present embodiment, the heater unit 41 is disposed at a side opposite to a side facing to the pressure roller 31 in the fixing unit 23. As shown in FIG. 3, the heater unit 41 is formed by disposing the induction heating coil 43 on a coil disposition member 42 and by providing a center core 44, a side core 45, and an arched core 46 around the induction heating coil 43 so as to surround the induction heating coil 43.

The induction heating coil 43 is disposed at a position distant from the fixing belt 28 and facing to the part of the outer circumferential side of the fixing belt 28. Still further, the induction heating coil 43 is formed by winding an insulation covered lead wire 43 in the axial direction of the fixing belt 28.

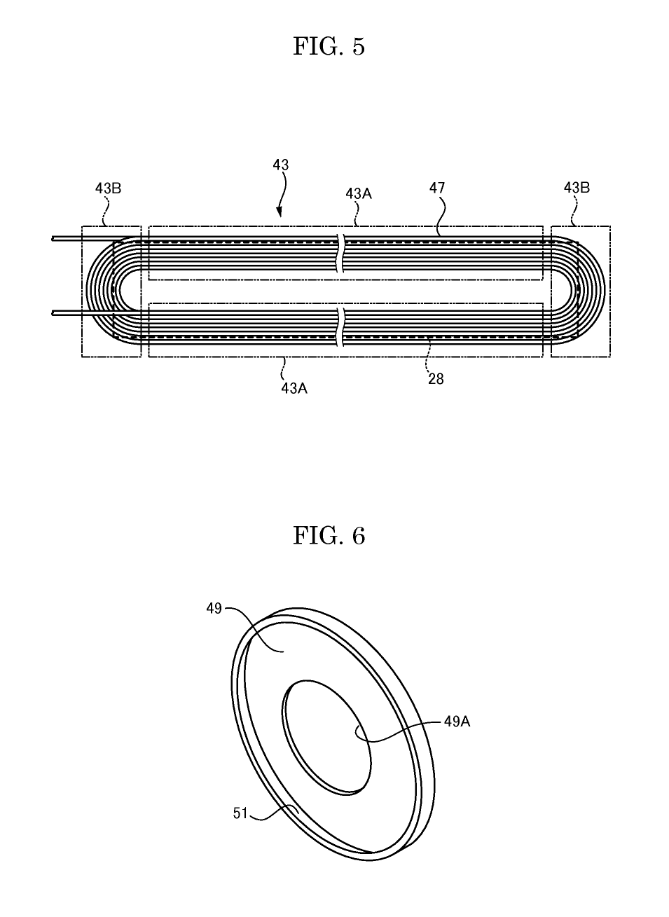

FIG. 5 illustrates the induction heating coil 43. As shown in FIG. 5, the induction heating coil 43 is formed at the position facing to the part of the outer circumferential side of the fixing belt 28 by repeatedly wiring the lead wire 47 at the position facing to the part of the outer circumferential side of the fixing belt 28 so as to straightly stretch the lead wire 47 from one end to another end in the axial direction of the fixing belt 28 and then to curve the lead wire 47 at the other end of the fixing belt 28 and further so as to straightly stretch the lead wire 47 from the other end to the one end of the fixing belt 28 and then to curve the lead wire 47 at the one end of the fixing belt 28.

The induction heating coil 43 includes a straight part 43A and a turning part 43B. That is, in the induction heating coil 43, the part where the lead wire 47 stretches straightly between the one end and the other end of the fixing belt 28 is the straight part 43A, and the part where the lead wire 47 is curved at the one end or the other end of the fixing belt 28 is the turning part 43B.

The induction heating coil 43 shown in FIG. 5 is what is looked down from an upper side in FIG. 3. A broken line in FIG. 5 indicates the fixing belt 28 disposed below the induction heating coil 43. As it is apparent from FIG. 5, in the present embodiment, each straight part 43A of the induction heating coil 43 stretches from a position slightly closer to a middle part from the one end of the fixing belt 28 to a position slightly closer to the middle part from the other end of the fixing belt 28 by passing through the middle part of the fixing belt 28. Still further, each turning part 43B of the induction heating coil 43 is disposed at a position facing to the end part of the fixing belt 28.

During the fixing operation, an alternating current is flown through the induction heating coil 43. Thereby, magnetic fluxes passing through the outer circumferential side of the fixing belt 28 are generated by the induction heating coil 43. Due to the magnetic fluxes, eddy currents are generated in the base layer of the fixing belt 28 formed of the magnetic metal, and the base layer generates heat.

Meanwhile, the fixing device 21 is provided with a pair of movement limiting members 49 limiting movement of the fixing belt 28 in the axial direction. As shown in FIG. 2, the pair of movement limiting members 49 are provided at both sides of the fixing belt 28, respectively. Because the fixing belt 28 is movable with respect to the elastic member 27, there is a case when the fixing belt 28 is shifted toward one side in the axial direction or is meandered in the axial direction. The movement limiting members 49 prevent the fixing belt 28 from shifting or meandering as described above by limiting the movement of the fixing belt 28 in the axial direction.

FIG. 6 illustrates one example of the movement limiting member 49. For example, as shown in FIG. 6, each movement limiting member 49 is formed into a disk-like shape and is provided with a hole 49A at a center thereof. An outer diameter of each movement limiting member 49 is larger than an outer diameter of the fixing belt 28. Still further, each movement limiting member 49 is formed of nonmagnetic metal, such as aluminum or copper. As shown in FIG. 4, each movement limiting member 49 is disposed at the outside of the end part of the fixing belt 28 in the axial direction so as to face to an end face of the fixing belt 28. Each movement limiting member 49 is fastened (unmovably attached) to the fixing shaft part 24 by attaching the hole 49A to the fixing shaft part 24. Still further, in a face of each movement limiting member 49 facing to a center side of the fixing belt 28 in the axial direction, a part of the face located at an outer circumferential side faces to the end face of the fixing belt 28. For example, when the fixing belt 28 moves one side in the axial direction, the end face of the one end of the fixing belt 28 abuts against the movement limiting member 49 and thereby, the movement of the fixing belt 28 in the axial direction is limited.

Moreover, each movement limiting member 49 is provided with each of magnetic flux suppressing parts 51. As shown in FIG. 6, each magnetic flux suppressing part 51 is formed in an outer circumferential part of each movement limiting member 49 and extends from the outer circumferential part of each movement limiting member 49 to the inside of the fixing belt 28 in the axial direction. Each magnetic flux suppressing part 51 is formed around the whole outer circumferential part of each movement limiting member 49 and is formed into a cylindrical shape as a whole. An outer diameter of each magnetic flux suppressing part 51 is larger than the outer diameter of the fixing belt 28. Each magnetic flux suppressing part 51 is formed integrally with each movement limiting member 49 and is formed of the same material with each movement limiting member 49, i.e., the nonmagnetic metal, such as aluminum or copper.

As shown in FIG. 4, each magnetic flux suppressing part 51 faces to the outer circumferential side of the end part of the fixing belt 28 and is distant from the outer circumferential side of the end part of the fixing belt 28. Because each magnetic flux suppressing part 51 is distant from the outer circumferential side of the fixing belt 28, the movement of the fixing belt 28 with respect to the elastic member 27 is not limited by the magnetic flux suppressing part 51. That is, it is possible to maintain the state in which the fixing belt 28 is movable with respect to the fixing shaft part 24.

FIG. 7 illustrates a part where the end part of the fixing belt 28 and the turning part 43B of the induction heating coil 43 face to each other in the fixing device 21 of the present embodiment. As shown in FIG. 7, each magnetic flux suppressing part 51 is positioned between the end part of the fixing belt 28 and the turning part 43B of the induction heating coil 43 facing to each other and interrupts between them. Still further, in a case when a gap G1 is made between the end part of the fixing belt 28 and each movement limiting member 49 due to the movement of the fixing belt 28 in the axial direction, each magnetic flux suppressing part 51 is positioned between the gap G1 and the turning part 43B of the induction heating coil 43 facing to each other and interrupts between them.

In order to reliably interrupt between the gap G1 and the turning part 43B of the induction heating coil 43, it is desirable to set a length in the axial direction of the magnetic flux suppressing part 51 to be longer than a maximum size of the gap G1 that can be made between the fixing belt 28 and each movement limiting member 49, for example.

Moreover, because each magnetic flux suppressing part 51 is formed around the entire circumference of the outer circumferential part of each movement limiting member 49, it is possible to always interrupt between the end part of the fixing belt 28 and the turning part 43B of the induction heating coil 43 and between the gap G1 and the turning part 43B of the induction heating coil 43 during when the fixing unit 23 is rotated.

Each magnetic flux suppressing part 51 interrupts the magnetic fluxes generated by the induction heating coil 43 from passing through the end part of the fixing belt 28 by thus interrupting between the end part of the fixing belt 28 and the turning part 43B of the induction heating coil 43 or between the gap G1 and the turning part 43B of the induction heating coil 43.

Meanwhile, as shown in FIG. 3, the fixing device 21 is provided with a conveying member 61 guiding the sheet to the nip part 35, a separating member 62 separating the sheet passed through the nip part 35 from the fixing belt 28, a thermistor 63 detecting temperature of the fixing belt 28, and others.

(Suppression of Magnetic Fluxes by Magnetic Flux Suppressing Part)

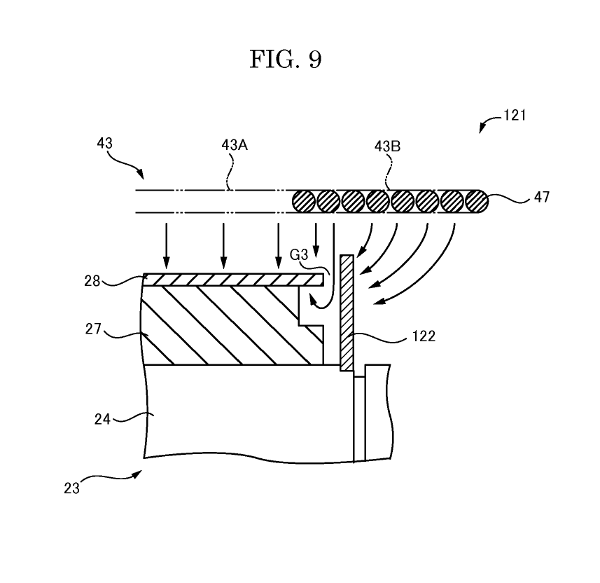

A magnetic flux suppressing action by each magnetic flux suppressing part 51 will be described below while comparing the fixing device 21 of the present embodiment of the present disclosure shown in FIG. 7 with a fixing device 111 of a first comparative example shown in FIG. 8 and a fixing device 121 of a second comparative example shown in FIG. 9.

Firstly, the fixing device 111 of the first comparative example shown in FIG. 8 is configured so that, instead of the movement limiting member 49 made of the nonmagnetic metal including the magnetic flux suppressing part 51 in the fixing device 21, a movement limiting member 112 having no magnetic flux suppressing part and formed of heat resistant resin is provided.

In the fixing device 111 of the first comparative example shown in FIG. 8, the lead wires are concentrated in the turning part 43B of the induction heating coil 43 as compared to the straight part 43A. Therefore, magnetic flux density of the turning part 43B is higher than that of the straight part 43A in a magnetic field formed by the induction heating coil 43.

Moreover, in the magnetic field generated by the induction heating coil 43, most of the magnetic fluxes generated by the straight part 43A enter/exit into/from the outer circumferential face of the fixing belt 28.

Whereas, some of the magnetic fluxes generated by the turning part 43B of the induction heating coil 43 enter/exit into/from the outer circumferential face of the fixing belt 28 and some enter into the inside of the fixing belt 28 from a gap G2 between the end part of the fixing belt 28 and the movement limiting member 112. Still further, in the fixing device 111 of the first comparative example, because the movement limiting member 112 is formed of not a magnetic material, but the heat resistant resin material, some of the magnetic fluxes generated by the turning part 43B of the induction heating coil 43 pass through the movement limiting member 112 and enter into the inside of the fixing belt 28. Then, the magnetic fluxes entered into the inside of the fixing belt 28 enter/exit into/from an inner circumferential face of the fixing belt 28.

As a result, in the fixing device 111 of the first comparative example, magnetic flux density of the magnetic fluxes passing through the end part of the fixing belt 28 is higher than that of magnetic fluxes passing through the intermediate part of the fixing belt 28. Therefore, heating temperature of the end part of the fixing belt 28 becomes higher than heating temperature of the intermediate part of the fixing belt 28. Accordingly, there is a possibility that the temperature rise of the end part of the fixing belt 28 becomes excessive.

Next, the fixing device 121 of the second comparative example shown in FIG. 9 is configured so that, instead of the movement limiting member 49 made of the nonmagnetic metal and having the magnetic flux suppressing part 51 of the fixing device 21, a movement limiting member 122 having no magnetic flux suppressing part and formed of nonmagnetic metal is provided.

In the fixing device 121 of the second comparative example shown in FIG. 9, similarly to the fixing device 111 of the first comparative example, because the lead wires are concentrated in the turning part 43B more than that in the straight part 43A, the magnetic flux density is higher in the turning part 43B than that of the straight part 43A in the magnetic field generated by the induction heating coil 43.

Moreover, in the fixing device 121 of the second comparative example, similarly to the fixing device 111 of the first comparative example, in the magnetic field generated by the induction heating coil 43, most of the magnetic fluxes generated in the straight part 43A enter/exit into/from the outer circumferential face of the fixing belt 28.

Furthermore, some of the magnetic fluxes generated by the turning part 43B of the induction heating coil 43 enter/exit into/from the outer circumferential face of the fixing belt 28 and some of those enter into the inside of the fixing belt 28 from a gap G3 between the end part of the fixing belt 28 and the movement limiting member 122. Then, the magnetic fluxes entering into the inside of the fixing belt 28 enter/exit into/from the inner circumferential face of the fixing belt 28. In the fixing device 121 of the second comparative example, because the movement limiting member 122 is formed of the nonmagnetic metal, the magnetic fluxes generated by the turning part 43B of the induction heating coil 43 and otherwise entering into the inside of the fixing belt 28 by passing through the movement limiting member 122 are suppressed naturally by the movement limiting member 122.

As a result, in the fixing device 121 of the second comparative example, although it is possible to suppress the magnetic fluxes from passing through the movement limiting member 122 and entering into the inside of the fixing belt 28 by forming the movement limiting member 122 by the nonmagnetic metal, it is unable to suppress the magnetic fluxes entering into the inside of the fixing belt 28 through the gap G3 between the end part of the fixing belt 28 and the movement limiting member 122. Accordingly, the magnetic flux density of the magnetic fluxes passing through the end part of the fixing belt 28 becomes higher than the magnetic flux density of the magnetic fluxes passing through the intermediate part of the fixing belt 28. Due to that, because heating temperature of the end part of the fixing belt 28 becomes higher than heating temperature of the intermediate part of the fixing belt 28, there is a possibility that the temperature rise of the end part of the fixing belt 28 becomes excessive.

Finally, the fixing device 21 of the present embodiment shown in FIG. 7 includes the movement limiting member 49 made of nonmagnetic metal and provided with the magnetic flux suppressing part 51 as described above.

In the fixing device 21 shown in FIG. 7, similarly to the fixing devices 111 and 121 of the two comparative examples as mentioned above, because the lead wires are concentrated in the turning part 43B of the induction heating coil 43 more than that in the straight part 43A, in the magnetic field generated by the induction heating coil 43, the magnetic flux density is higher in the turning part 43B than that in the straight part 43A.

Moreover, in the fixing device 21 shown in FIG. 7, similarly to the fixing devices 111 and 121 of the two comparative examples as mentioned above, in the magnetic field formed by the induction heating coil 43, most of the magnetic fluxes generated by the straight part 43A enter/exit into/from the outer circumferential face of the fixing belt 28.

However, in the fixing device 21 shown in FIG. 7, the magnetic fluxes generated by the turning part 43B of the induction heating coil 43 are suppressed from entering/exiting into/from the outer circumferential face of the fixing belt 28 by the magnetic flux suppressing parts 51 formed of the nonmagnetic metal similarly to the movement limiting members 49. Still further, the magnetic fluxes generated by the turning part 43B of the induction heating coil 43 are also suppressed from entering into the inside of the fixing belt 28 through the gap G1 between the end part of the fixing belt 28 and the movement limiting members 49 by the magnetic flux suppressing parts 51. The magnetic fluxes generated by the turning part 43B of the induction heating coil 43 are suppressed from passing through the movement limiting member 49 to enter into the inside of the fixing belt 28 by the movement limiting member 49 made of the nonmagnetic metal.

As described above, according to the fixing device 21 of the present embodiment of the present disclosure, it is possible to suppress the magnetic fluxes generated by the turning part 43B of the induction heating coil 43 from passing through the end part of the fixing belt 28 by the movement limiting member 49 and the magnetic flux suppressing part 51 made of the nonmagnetic metal. Accordingly, it is possible to reduce the magnetic flux density of the magnetic fluxes passing through the end part of the fixing belt 28 to a level equal or less than the magnetic flux density of the magnetic fluxes passing through the intermediate part of the fixing belt 28. Due to that, it is possible to prevent the heating temperature of the end part of the fixing belt 28 from becoming higher than the heating temperature of the intermediate part of the fixing belt 28 and to prevent excessive temperature rise of the end part of the fixing belt 28.

### Second Embodiment

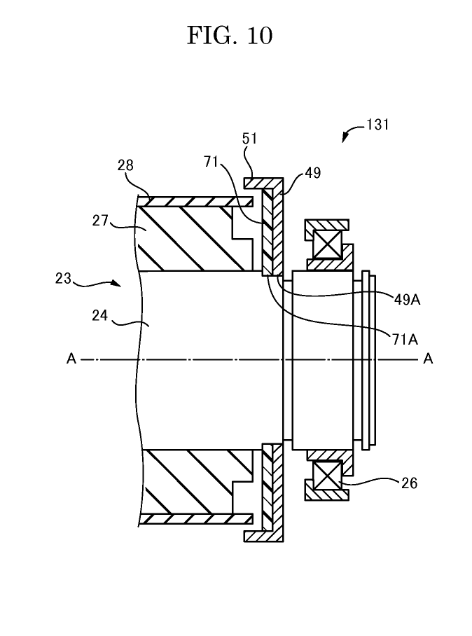

FIG. 10 illustrates a part of a fixing device 131 of a second embodiment of the present disclosure. In the fixing device 131 of the second embodiment of the present disclosure, the same or corresponding components with those of the fixing device 21 of the first embodiment of the present disclosure as described above will be denoted by the same reference numerals and an explanation thereof will be omitted here.

As shown in FIG. 10, in the fixing device 131 of the second embodiment of the present disclosure, the respective movement limiting member 49 (only one side is shown) is provided with sliding contact members 71. Each sliding contact member 71 is a member coming into contact with the end face of the end part of the fixing belt 28 and allowing the fixing belt 28 to move smoothly in a circumferential direction when the fixing belt 28 is moved toward each movement limiting member 49 in the axial direction.

That is, in a case where there is no sliding contact member 71, if the fixing belt 28 is shifted with respect to the elastic member 27 toward each movement limiting member 49 in the axial direction, the end face of the end part of the fixing belt 28 comes into contact with each movement limiting member 49. Then, if the fixing belt 28 is shifted with respect to the elastic member 27 in the circumferential direction in the condition in which the end face of the fixing belt 28 comes into contact with each movement limiting member 49, the end face of the fixing belt 28 is slid on a surface of each movement limiting member 49. Because each movement limiting member 49 is formed of a metallic material, the surface of each movement limiting member 49 is rough. As a result, if the end face of the fixing belt 28 is slid on the surface of each movement limiting member 49, large friction occurs between the end face of the fixing belt 28 and the surface of each movement limiting member 49. Then, due to the friction, there is a possibility of breaking the end part of the fixing belt 28 and of damaging the fixing belt 28.

By contrast, the fixing device 131 of the second embodiment of the present disclosure is provided with the sliding contact members 71 in the movement limiting members 49. Each sliding contact member 71 is formed of a resin material. The resin material that can be used for each sliding contact member 71 is PEEK (polyether etherketone), LCP (liquid crystal polymer) or the like, for example. The resin material used for each sliding contact member 71 is preferable to have heat resistant. Because each sliding contact member 71 is formed of such material, a surface of each sliding contact member 71 is more slippery than the surface of each movement limiting member 49. Still further, in the present embodiment, each sliding contact member 71 is formed into a disk-like shape and is provided with an insertion hole 71A at a center thereof. The end part of the fixing shaft part 24 is inserted through the insertion hole 71A. An outer diameter of each sliding contact member 71 is equal to or larger than the outer diameter of the fixing belt 28. Still further, each sliding contact member 71 is disposed on a face of each movement limiting member 49 at a side facing to the end face of the fixing belt 28. Each sliding contact member 71 is also fastened to each movement limiting member 49 or the fixing shaft part 24 by means of bonding or fitting, for example.

Each sliding contact member 71 faces to the end face of the end part of the fixing belt 28. When the fixing belt 28 is shifted toward each movement limiting member 49 in the axial direction, the end face of the end part of the fixing belt 28 comes into contact with the surface of each sliding contact member 71. Then, when the fixing belt 28 is shifted in the circumferential direction in the condition in which the end face of the fixing belt 28 comes into contact with each sliding contact member 71, the end face of the fixing belt 28 is slid on the surface of each sliding contact member 71. Because the surface of each sliding contact member 71 is a smooth slippery surface, friction generated between the end face of the fixing belt 28 and each sliding contact member 71 is small. Accordingly, this arrangement makes it possible to prevent the end face of the fixing belt 28 from being damaged by the friction caused by the contact.

Thus, according to the fixing device 131 of the second embodiment of the present disclosure, it is possible to prevent the end part of the fixing belt 28 from being damaged and to prolong a life of the fixing belt by arranging such that the end face of the fixing belt 28 shifted in the axial direction comes into contact with the sliding contact member 71.

Incidentally, in the embodiment as described above, as shown in FIG. 4, when the gap of maximum size that can be made between the fixing belt 28 and each movement limiting member 49 is made, a length in the axial direction of each magnetic flux suppressing part 51 is set to be a length enabling to interrupt between the gap and the induction heating coil 43. However, the length in the axial direction of each magnetic flux suppressing part 51 is set to be a size shorter than a size that enables to interrupt between the end part of the fixing belt 28 and the whole of a part of the induction heating coil 43 facing to the end part of the fixing belt 28, as shown in FIG. 4. The present disclosure is not limited to the configuration of the embodiment, and the length in the axial direction of each magnetic flux suppressing part 51 may be set to be a size that enables to interrupt between the end part of the fixing belt 28 and the whole of the part of the induction heating coil 43 facing to the end part of the fixing belt 28. That is, the length of each magnetic flux suppressing part 51 may be extended toward the inside in the axial direction so as to be able to interrupt between the end part of the fixing belt 28 and the whole of the part of the induction heating coil 43 facing to the end part of the fixing belt 28 by each magnetic flux suppressing part 51. Still further, each magnetic flux suppressing part 51 may be extended to the outside in the axial direction over each movement limiting member 49.

Moreover, while the case of providing the magnetic flux suppressing parts 51 respectively to the pair of movement limiting members 49 provided at both sides of the fixing belt 28 has been exemplified in each embodiment as described above, the present disclosure is not limited to such configuration. For instance, there is a case of the fixing device configured so that the turning part 43B of the induction heating coil 43 and the end part of the fixing belt 28 face to each other at one side in the axial direction, but the turning part 43B of the induction heating coil 43 and the end part of the fixing belt 28 do not face to each other at another side in the axial direction. In this case, the magnetic flux suppressing part 51 may be provided on the movement limiting member 49 disposed at the one side in the axial direction and the magnetic flux suppressing part needs not be provided on the movement limiting member 49 disposed at the other side in the axial direction.

Furthermore, in the fixing device configured so that the end part of the fixing belt 28 and the turning part 43B of the induction heating coil 43 do not face to each other, there is a case where the magnetic fluxes enter into a gap formed between the end part of the fixing belt 28 and the movement limiting member 49, and then, the temperature of the end part of the fixing belt 28 rises excessively. In such a fixing device, by providing the magnetic flux suppressing part 51, it is possible to suppress the magnetic fluxes otherwise from entering into the gap as described above and to prevent the temperature of the end part of the fixing belt 28 from excessively rising.

Still further, although each embodiment as described above was described in a case of applying the configuration of the present disclosure to the printer. However, the present disclosure is not limited to such case and is applicable also to a copying machine, a facsimile machine, a multifunction peripheral, or the like. Still further, the present disclosure is applicable not only to the apparatus performing color printing but also to an apparatus performing monochrome printing.

While the preferable embodiment and its modified example of the image forming apparatus of the present disclosure have been described above and various technically preferable configurations have been illustrated, a technical range of the disclosure is not to be restricted by the description and illustration of the embodiment. Further, the components in the embodiment of the disclosure may be suitably replaced with other components, or variously combined with the other components. The claims are not restricted by the description of the embodiment of the disclosure as mentioned above.

What is claimed is:

1. A fixing device fixing an image on a recording medium, comprising:
a fixing shaft part configured so as to be rotatable around a first axis;
an endless fixing belt provided movably with respect to the fixing shaft part at an outer circumferential side of the fixing shaft part;
a pressure roller provided rotatably around a second axis in parallel with the first axis and forming a nip part with the fixing belt by being pressed against the fixing belt;
an induction heating coil disposed at a position facing to a part at the outer circumferential side of the fixing belt, formed by repeatedly wiring a lead wire so as to straightly stretch the lead wire from one end to another end in an axial direction of the fixing belt and then to curve the lead wire at the other end of the fixing belt and further so as to straightly stretch the lead wire from the other end to the one end of the fixing belt and then to curve the lead wire at the one end of the fixing belt, and configured so as to heat the fixing belt;
a movement limiting member provided on the fixing shaft part, disposed at the outside in the axial direction from an end part at one side or another side in the axial direction of the fixing belt so as to face to an end face of the end part of the fixing belt, and configured so as to limit movement in the axial direction of the fixing belt with respect to the fixing shaft part; and
a magnetic flux suppressing part formed in an outer circumferential part of the movement limiting member, extending from the outer circumferential part of the movement limiting member to the inside of the fixing belt in the axial direction, and interrupting between a part of the induction heating coil facing to the end part of the fixing belt and the end part of the fixing belt to suppress magnetic fluxes generated by the induction heating coil from passing through the end part of the fixing belt.

2. The fixing device according to claim 1, wherein the magnetic flux suppressing part is formed around an entire circumference of the outer circumferential part of the movement limiting member.

3. The fixing device according to claim 1, wherein the magnetic flux suppressing part faces to an outer circumferential face of the end part of the fixing belt and is distant from the outer circumferential face of the end part of the fixing belt.

4. The fixing device according to claim 1, wherein the movement limiting member and the magnetic flux suppressing part are formed of nonmagnetic metal.

5. The fixing device according to claim 1 further comprising:
a sliding contact member formed of a resin member and provided at a part of the movement limiting member facing to the end face of the end part of the fixing belt,
wherein the end face of the end part of the fixing belt is slid on and contact with the sliding contact member when the fixing belt is moved toward the movement limiting member in the axial direction.

6. An image forming apparatus including the fixing device as set forth in claim 1.

7. An image forming apparatus including the fixing device as set forth in claim 2.

8. An image forming apparatus including the fixing device as set forth in claim 3.

9. An image forming apparatus including the fixing device as set forth in claim 4.

10. An image forming apparatus including the fixing device as set forth in claim 5.
